(19) United States
(12) Patent Application Publication
(10) Pub. No.: US 2021/0012183 A1
(43) Pub. Date: Jan. 14, 2021

(54) METHOD AND DEVICE FOR ASCERTAINING A NETWORK CONFIGURATION OF A NEURAL NETWORK

(71) Applicants: Robert Bosch GmbH, Stuttgart (DE); Albert-Ludwigs-Universitaet Freiburg, Freiburg (DE)

(72) Inventors: Thomas Elsken, Sindelfingen (DE); Frank Hutter, Freiburg (DE); Jan Hendrik Metzen, Boeblingen (DE)

(21) Appl. No.: 16/978,108

(22) PCT Filed: Apr. 17, 2019
(86) PCT No.: PCT/EP2019/059991

§ 371 Date: Sep. 3, 2020

(30) Foreign Application Priority Data
Apr. 24, 2018 (DE) 10 2018 109 835.9

(51) Int. Cl. G06N 3/063; G06K 9/62; G06N 3/08; G06N 7/00

(52) U.S. Cl. CPC G06N 3/063; G06N 7/005; G06N 3/08; G06K 9/6256

(57) ABSTRACT

A method for ascertaining a suitable network configuration for a neural network. The method includes: a) providing an instantaneous network configuration set that includes network configurations corresponding to a Pareto set with regard to a prediction error and at least one further optimization target; b) providing a set of network configuration variants; c) selecting network configurations from the set of network configuration variants based on a probability distribution of the network configurations of the instantaneous network configuration set with regard to the at least one further optimization target; d) training neural networks of each of the selected network configurations and determining a corresponding prediction error; e) updating the instantaneous network configuration set as a function of the prediction errors and the at least one further optimization target of the network configuration set and the selected network configurations; and f) selecting the suitable network configuration from the instantaneous network configuration set.

### FIELD

The present invention relates to neural networks, in particular for implementing functions of a technical system, in particular a robot, a vehicle, a tool, or a work machine. Moreover, the present invention relates to the architecture search of neural networks in order to find for a certain application a configuration of a neural network that is optimized with regard to a prediction error and with regard to one or multiple optimization targets.

### BACKGROUND INFORMATION

The properties of neural networks are determined primarily by their architecture. The architecture of a neural network is defined, for example, by its network configuration, which is specified, among other things, by the number of neuron layers, the type of neuron layers (linear transformations, nonlinear transformations, normalization, linkage with further neuron layers, etc.), and the like. In particular with increasing complexity of the applications and of the tasks to be performed, randomly finding suitable network configurations is laborious, since each candidate of a network configuration must initially be trained to allow its performance to be evaluated.

To improve the search for a suitable network configuration, expert knowledge is generally applied in order to reduce the number of candidates for possible network configurations prior to their training. In this way, a search may be made in a subset of meaningful network architectures.

Despite this approach, the set of possible network configurations is immense. Since an assessment of a network configuration is determined only after a training, for example by evaluating an error value, for complex tasks and correspondingly complex network configurations this results in significant search times for a suitable network configuration.

In addition, for most practical applications neural networks are required that are optimized with regard to the prediction error and also with regard to at least one further optimization target that results, for example, from hardware limitations and the like.

### SUMMARY

According to the present invention, a method for determining a network configuration for a neural network, based on training data for a given application, and a corresponding device, are provided.

Example embodiments of the present invention are described herein.

According to a first aspect of the present invention, a method for ascertaining a suitable network configuration for a neural network for a predefined application, in particular for implementing functions of a technical system, in particular a robot, a vehicle, a tool, or a work machine, is provided, the application being determined in the form of training data, and the network configuration indicating the architecture of the neural network. In accordance with an example embodiment of the present invention, the method includes the following steps:
a) providing an instantaneous network configuration set that includes network configurations, the instantaneous network configuration set corresponding to a Pareto set with regard to a prediction error and at least one further optimization target;
b) providing a set of network configuration variants as a function of a probability distribution of the network configurations in the instantaneous network configuration set;
c) selecting network configurations from the set of network configuration variants as a function of a probability distribution of the network configurations of the instantaneous network configuration set with regard to the at least one further optimization target;
d) determining a prediction error for each of the selected network configurations;
e) updating the instantaneous network configuration set as a function of the prediction errors and the further optimization targets of the selected network configurations; and
f) selecting the suitable network configuration from the instantaneous network configuration set.

One object of the above example method is to find a set of network configurations that represents an improved selection option for finding an optimized network configuration of a neural network, based on a predefined application. In particular, for this purpose it is desirable to select the network configurations in question in such a way that they are optimized with regard to a prediction error and one or multiple further optimization targets, so that a suitable network configuration may be selected with discretion from the found set of network configurations. According to the example method, the example method ascertains an optimized Pareto set of suitable network configurations with regard to a prediction error and one or multiple further optimization targets in a preferably resource-saving manner.

The Pareto set of network configurations corresponds to those network configurations in which the neural network in question is not dominated by another network configuration with regard to all optimization targets. In other words, the Pareto set of network configurations corresponds to those network configurations that are selected in such a way that each of the network configurations is better than any of the other network configurations, at least with regard to the prediction error or with regard to at least one of the one or multiple further optimization targets. In particular, the aim of the present invention is ascertain a Pareto set with regard to the prediction error and with regard to the at least one further optimization target in order to obtain a reduced selection set for network configurations.

The above example method allows the selection of possible network configurations, which are optimized with regard to the prediction error and with regard to one or multiple further optimization targets, to be made in order to find a suitable network configuration for a neural network for a given application. Since determining the prediction error requires a particular training of the neural network corresponding to a network configuration candidate, the above method also provides for suitably selecting the network configuration candidates for the training according to a preselection. The selection takes place corresponding to a probability distribution, with preference for the network configuration for cost values of the one or multiple optimization targets for which yet no, or no better, network configuration has been evaluated with regard to the predictive accuracy. This results in network configuration variants along a Pareto set that provides an optimized selection option with respect to the specific application. An expert may make an appropriate selection of a suitable network configuration, based on a weighting of the optimization targets.

In addition, steps a) through e) may be carried out iteratively multiple times.

In particular, the method may be ended when an abort condition is met, the abort condition involving the occurrence of at least one of the following events:
a predetermined number of iterations has been reached,
a predetermined prediction error value has been reached by at least one of the network configuration variants.

It may be provided that those network configurations which have the lowest probabilities as a function of the probability distribution of the network configurations of the instantaneous network configuration set are selected from the set of network configuration variants.

For example, the network configurations may be selected from the set of network configuration variants as a function of a density estimate, in particular a kernel density estimate, that is ascertained from the instantaneous network configuration set.

According to one specific embodiment of the present invention, the training data may be predefined by input parameter vectors and output parameter vectors associated with same, the prediction error of the particular network configuration being determined as a measure that results from the particular deviations between model values that result from the neural network, determined by the particular network configuration, based on the input parameter vectors, and from the output parameter vectors associated with the input parameter vectors.

In addition, the prediction errors for the selected network configurations may be ascertained by a training using the training data under training conditions that are predetermined together, the training conditions that are predetermined together specifying a number of training passes and/or a training time and/or a training method.

Furthermore, the suitable network configuration may be selected from the instantaneous network configuration set, based on an overall cost function that is a function of the prediction error and resource costs with regard to the at least one optimization target.

According to one specific embodiment of the present invention, the updating of the instantaneous network configuration set may be carried out in such a way that an updated network configuration set contains only those network configurations from the instantaneous network configuration set and from the selected network configurations which, with regard to the prediction error and at least one of the one or multiple optimization targets, are better than any of the other network configurations.

In addition, the updating of the instantaneous network configuration set may be carried out by adding the selected network configurations to the instantaneous network configuration set in order to obtain an expanded network configuration set, and subsequently removing from the expanded network configuration set those network configurations which, with regard to the prediction error and all of the one or multiple optimization targets, are poorer than at least one of the other network configurations in order to obtain the updated network configuration set.

According to a further aspect of the present invention, a method for providing a neural network that includes a network configuration that has been ascertained using the above method is provided, the neural network being designed in particular for implementing functions of a technical system, in particular a robot, a vehicle, a tool, or a work machine.

According to a further aspect of the present invention, a use of a neural network that includes a network configuration that has been created using the above method for the predefined application is provided, the neural network being designed in particular for implementing functions of a technical system, in particular a robot, a vehicle, a tool, or a work machine.

According to a further aspect of the present invention, a device for ascertaining a suitable network configuration for a neural network for a predefined application, in particular functions of a technical system, in particular a robot, a vehicle, a tool, or a work machine, is provided, the application being determined in the form of training data; the network configuration indicating the architecture of the neural network. In accordance with an example embodiment of the present invention, the device is designed for carrying out the following steps:
a) providing an instantaneous network configuration set that includes network configurations, the instantaneous network configuration set corresponding to a Pareto set with regard to a prediction error and at least one further optimization target;
b) providing a set of network configuration variants;
c) selecting network configurations from the set of network configuration variants as a function of a probability distribution of the network configurations of the instantaneous network configuration set with regard to the at least one further optimization target;
d) training neural networks of each of the selected network configurations and determining a corresponding prediction error;
e) updating the instantaneous network configuration set as a function of the prediction errors and the at least one further optimization target of the network configuration set and the selected network configurations; and
f) selecting the suitable network configuration from the instantaneous network configuration set.

According to a further aspect of the present invention, a control unit, in particular for controlling functions of a technical system, in particular a robot, a vehicle, a tool, or a work machine, that includes a neural network is provided, the control unit being configured with the aid of the above method.

### BRIEF DESCRIPTION OF THE DRAWINGS

Specific embodiments of the present invention are explained in greater detail below with reference to the figures.

FIG. 1 shows a schematic illustration of an example of a neural network.

FIG. 2 shows one possible network configuration of a neural network.

FIG. 3 shows a flow chart for illustrating a method for ascertaining a Pareto-optimal set of network configurations for ascertaining a suitable network configuration candidate for a predefined application, in accordance with an example embodiment of the presesent invention.

FIG. 4 shows a schematic illustration of a Pareto front of network configurations as a function of the prediction error and a further optimization parameter, in particular a resource utilization parameter.

### DETAILED DESCRIPTION OF EXAMPLE EMBODIMENTS

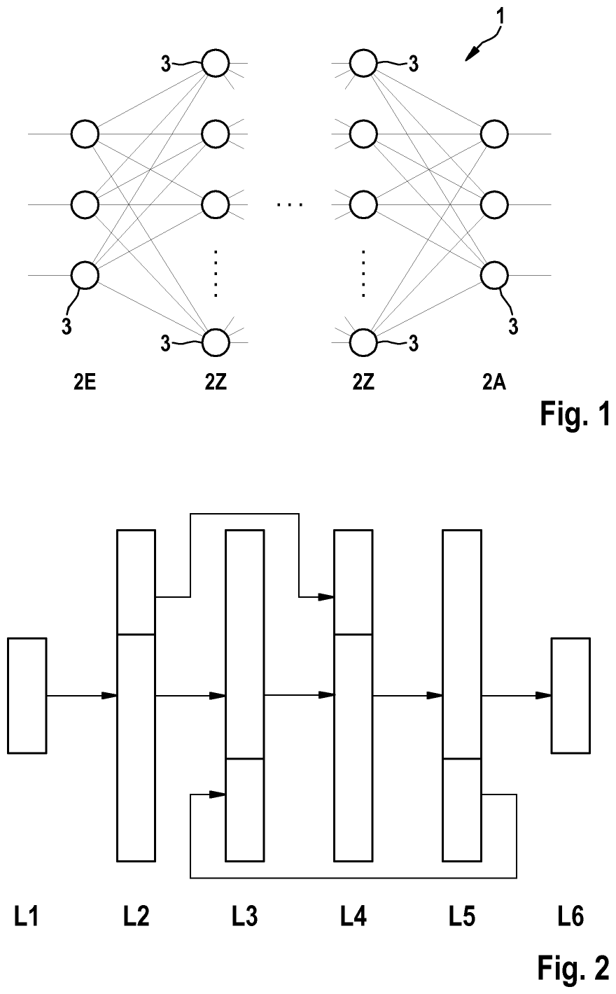

FIG. 1 shows the basic design of a neural network 1, which generally includes multiple cascaded neuron layers 2, each including multiple neurons 3. Neuron layers 2 include an input layer 2E for applying input data, multiple intermediate layers 2Z, and an output layer 2A for outputting computation results.

Neurons 3 of neuron layers 2 may correspond to a conventional neuron function

$${O}_{j} = ϕ ( {\sum }_{i = 1}^{M} ( {x}_{i} {w}_{i , j} ) - {θ}_{j} ) ,$$

where Oⱼ is the neuron output of the neuron, φ is the activation function, xᵢ is the particular input value of the neuron, w_{i,j} is a weighting parameter for the ith neuron input in the jth neuron layer, and θⱼ is an activation threshold. The weighting parameters, the activation threshold, and the selection of the activation function may be stored as neuron parameters in registers of the neuron.

The neuron outputs of a neuron 3 may each be passed on as neuron inputs to neurons 3 of the other neuron layers, i.e., one of the subsequent or one of the preceding neuron layers 2, or, if a neuron 3 of output layer 2A is involved, may be output as a computation result.

Neural networks 1 formed in this way may be implemented as software, or with the aid of computation hardware that maps a portion or all of the neural network as an electronic (integrated) circuit. Such computation hardware is then generally selected for building a neural network when the computation is to take place very quickly, which would not be achievable with a software implementation.

The structure of the software or hardware in question is predefined by the network configuration, which is determined by a plurality of configuration parameters. The network configuration determines the computation rules of the neural network. In a conventional network configuration as schematically shown in FIG. 1, for example, the configuration parameters include the number of neuron layers, the particular number of neurons in each neuron layer, the network parameters which are specified by the weightings, the activation threshold, and an activation function, information for coupling a neuron to input neurons and output neurons, and the like.

Apart from the network configuration described above, further configurations of neural networks are possible in which neurons are provided, which on the input side are coupled to neurons from various neuron layers, and which on the output side are coupled to neurons of various neuron layers. Furthermore, in this regard in particular neuron layers may also be provided which provide back-coupling, i.e., which on the input side are provided with neuron layers which, with respect to the data flow, are provided on the output side of the neuron layer in question.. In this regard, FIG. 2 schematically shows one possible configuration of a neural network that includes multiple layers L1 through L6 which are initially coupled to one another in a conventional manner, as schematically illustrated in FIG. 1; i.e., neuron inputs are linked to neuron outputs of the preceding neuron layer. In addition, neuron layer L3 includes an area which on the input side is coupled to neuron outputs of neuron layer L5. Neuron layer L4 may also be provided for being linked on the input side to outputs of neuron layer L2.

In the following discussion, a method in accordance with an example embodiment of the present invention for determining an optimized network configuration for a neural network, based on a predetermined application, is carried out. The application is determined essentially by the magnitude of input parameter vectors and their associated output parameter vectors, which represent the training data that define a desired network behavior or a certain task.

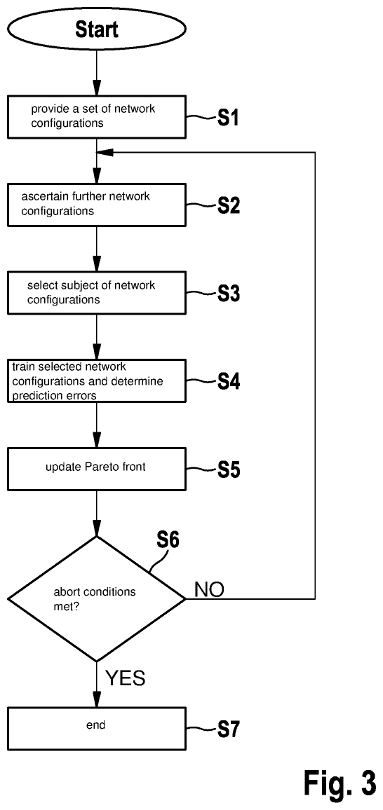

A method for ascertaining a set of suitable network configurations for a neural network based on a desired application is shown in FIG. 3. The set thus obtained is to be used to facilitate the selection of a network configuration for the desired application. The network configuration is therefore to indicate a neural network that is usable and suitable for a certain application, and optimized with regard to a prediction error and additionally with regard to at least one further optimization target. In particular, the set of network configurations is to correspond to a Pareto front or a Pareto set of network configurations that are optimized with regard to the prediction error and the at least one further optimization target.

The objective of the present invention is to approximate the Pareto front of the function

f(N)=(error(N), f(N))^{T} ∈ [symbol] ×

[symbol]

where N is a neural network, error(N) is the prediction error of the neural network based on validation data that describe an application, and f(N) is an arbitrary N-dimensional function that describes the required resources of neural network N in the form of costs of the particular resource (resource costs), i.e., resource costs with regard to one or multiple optimization targets in addition to the prediction error. The additional optimization targets may relate to properties of the resource for the computation hardware, among other things, for example: a memory size, an evaluation speed, a compatibility with regard to particular hardware, an evaluation energy consumption, and the like. The method takes into account that the evaluation of the prediction error is very complex, since it requires training of the neural network of the network configurations. In contrast, it is a significantly less complex effort to evaluate f(N) based on the at least one additional optimization target, since no training of neural network N is necessary for this purpose.

The method described below in conjunction with FIG. 3 approximates in an iterative manner the Pareto front of the above function.

A set of network configurations that represents a predefined initial Pareto front P₁, i.e., an instantaneous set of network configurations, is provided in step S1. The network configurations each correspond to a neural network with a certain network architecture. The neural network in question may include a conventional neural network, a convolutional neural network, or any other teachable networks such as recurrent neural networks.

Further/new network configurations, i.e., variants of network configurations, may be ascertained in step S2 based on the instantaneous set of network configurations. These may be ascertained, for example, by applying various network morphisms to one or more of the network configuration variants of network configurations, or may be selected randomly. In general, the generation of the variants of network configurations may take place in essentially any manner.

The network morphisms correspond to predetermined rules that may be determined with the aid of an operator. A network morphism is generally an operator T that maps a neural network N onto a network TN, where the following applies:

N^{w} (x)=(TN)^{\tilde{w}}(x) for x ∈X,

where ware the network parameters (weightings) of neural network N, and \tilde{w} are the network parameters of varied neural network TN. X corresponds to the space to which the neural network is applied.

k network configuration variants are obtained due to the variations in the network configurations of the instantaneous network configuration set of step S2. The network configuration variants may also be generated in some other way, in particular also independently of the particular instantaneous network configuration set.

A subset of j network configurations is selected from number k of network configuration variants in step S3. The selection may be made based on a density estimate, in particular a kernel density estimate p_{kde} as a function of instantaneous Pareto front Pᵢthat is computed for {f(N)|N ∈Pᵢ}. Alternative density estimation methods include parametric density models (a Gaussian mixture model, for example) or a histogram.

The kernel density estimate is a statistical method for estimating the probability distribution of a random variable. The kernel density estimate here correspondingly represents a function p_{kde} that indicates a degree of probability of the occurrence of a certain network configuration, based on a probability distribution that is determined by the network configurations of the instantaneous network configuration set.

The selection of the subset of the network configurations is then made randomly according to a probability distribution p that is antiproportional to p_{kde}; i.e., the probability that a neural network N belongs to k network configurations corresponds to

p(N)=c/p_{kde} (N)),

where c merely represents a constant for normalizing the probability distribution. Instead of the above relationship, some other relationship may also be used that meets the condition:

p_{kde}(f (N¹)) <p_{kde}(f (N2))→p(N1)>=p(N2)

If the kernel density estimated value of kernel density estimate p_{kde}(f(N*)) is large for a selected one of network configuration variants N*, which is the case when many network configurations of the instantaneous network configuration set already have the same value of approximately f(N), network configuration variant N* in question is not likely to further improve this value. If the kernel density estimated value of kernel density estimate p_{kde}(f(N*)) is small for a selected one of network configuration variants N*, which is the case when very few network configurations of the instantaneous network configuration set have the same value of approximately f(N), the probability that network configuration variant N* in question will improve this value is great. This means that of the network configuration variants, network configurations are selected that have a higher probability of belonging to the Pareto front of instantaneous network configuration set, i.e., of improving the approximation.

The evaluation of f(N) is very easy to carry out with little computing time, so that the particular instantaneous set of network configuration variants may be selected to be very large. The number of network configurations selected therefrom largely determines the computing time, since these network configurations must be trained in order to ascertain the particular prediction error.

The selected network configurations are trained with identical training data under predetermined training conditions, and the corresponding prediction errors are determined, in a subsequent step S4.

During the training of the neural networks that are predefined by the network configuration variants, the aim is to obtain an identical evaluation standard. Therefore, the training of the neural networks of all network configurations takes place for a predetermined number of training cycles and a predetermined training algorithm.

The updating of the Pareto front corresponding to the ascertained prediction errors and the resource costs with regard to the one or multiple further optimization targets is carried out in step S5. The updating of Pareto front Pᵢ with the network configurations of the instantaneous set of network configurations takes place in such a way that the selected network configurations are added to the instantaneous network configuration set in order to obtain an expanded network configuration set, and those network configurations which, with regard to the prediction error and all of the one or multiple optimization targets, are poorer than at least one of the other network configurations are subsequently removed from the expanded network configuration set.

A check is made in a subsequent step S6 as to whether an abort condition is met. If this is the case (alternative: yes), the method is continued with step S7; otherwise (alternative: no), the method goes back to step S2. The abort condition may include:
a predetermined number of iterations having been reached,
a predetermined prediction error value having been reached by at least one of the network configuration variants.

In this way, the particular instantaneous set of network configurations that is suitable for the application in question may be iteratively approximated to the Pareto front of optimized network configurations.

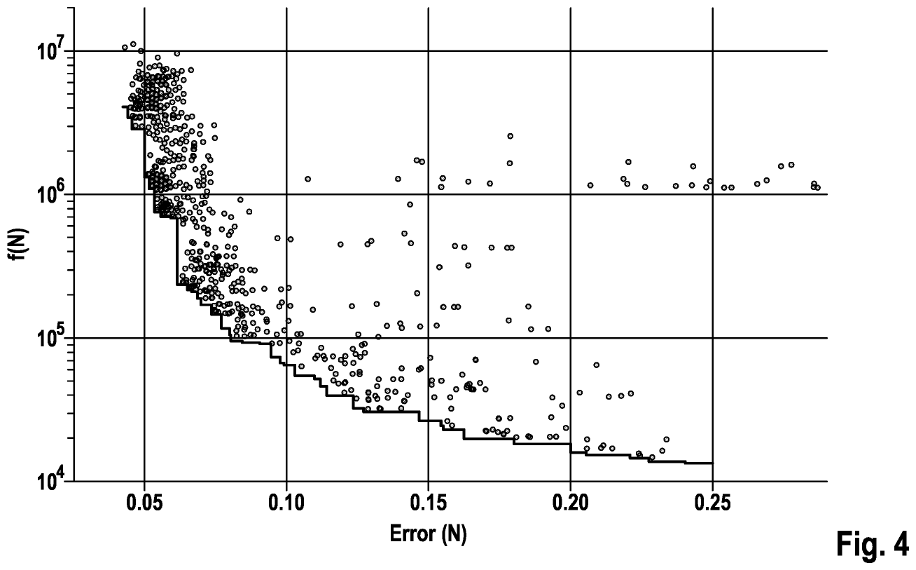

FIG. 4 illustrates an example of the pattern of a Pareto front of a set of network configurations with regard to prediction error error(N) and the resource costs with regard to at least one further optimization target f(N).

The network configurations of the instantaneous network configuration set ascertained after the most recent iteration cycle now represent a basis for selecting a suitable network configuration for the application determined by the training data. This may take place, for example, by specifying an overall cost function that takes into account the prediction error and the resource costs. In practice, it would be decided, based on the application in question, which network configuration of the instantaneous network configuration set (instantaneous Pareto front) is best suited for the selected application. This may take place based on a limiting specification. As an example scenario, a network configuration may be selected from the Pareto front which does not exceed a network size of 1 GB memory, for example.

The above method allows the architecture search of network configurations to be speeded up in an improved manner, since the evaluation of the performance/prediction error of the variants of network configurations may be carried out significantly more quickly.

The network configurations thus ascertained may be used for selecting a suitable configuration of a neural network for a predefined task. The optimization of the network configuration is closely related to the task at hand. The task results from the specification of training data, so that prior to the actual training, initially the training data from which the optimized/suitable network configuration for the given task is ascertained must be defined. For example, image recognition and image classification methods may be defined by training data containing input images, object associations, and object classifications. In this way, network configurations may be determined for all tasks defined by training data.

A neural network configured in this way may thus be used in a control unit of a technical system, in particular in a robot, a vehicle, a tool, or a work machine, in order to determine output variables as a function of input variables. The output variables may include, for example, a classification of the input variable (for example, an association of the input variable with a class of a predefinable plurality of classes), and in the case that the input data include image data, the output variables may include an in particular pixel-by-pixel semantic segmentation of these image data (for example, an area-by-area or pixel-by-pixel association of sections of the image data with a class of a predefinable plurality of classes). In particular, sensor data or variables ascertained as a function of sensor data are suitable as input variables of the neural network. The sensor data may originate from sensors of the technical system, or may be externally received from the technical system. The sensors may include in particular at least one video sensor and/or at least one radar sensor and/or at least one LIDAR sensor and/or at least one ultrasonic sensor. A processing unit of the control unit of the technical system may control at least one actuator of the technical system with a control signal as a function of the output variables of the neural network. For example, a movement of a robot or vehicle may thus be controlled, or a control of a drive unit or of a driver assistance system of a vehicle may take place.

1-16. (canceled)

17. A method for ascertaining a suitable network configuration for a neural network for a predefined application for implementing functions of a technical system including a robot, or a vehicle, or a tool, or a work machine, the predefined application being determined in the form of training data, the network configuration indicating an architecture of the neural network, the method comprising the following steps:
a) providing an instantaneous network configuration set that includes network configurations, the instantaneous network configuration set corresponding to a Pareto set with regard to a prediction error and at least one further optimization target;
b) providing a set of network configuration variants as a function of variations of the network configurations of the instantaneous network configuration set;
c) selecting a subset of network configurations from the provided set of network configuration variants as a function of a probability distribution, the probability distribution characterizing a distribution of the instantaneous network configuration set, with respect to the at least one further optimization target;
d) training neural networks of each of the selected subset of network configurations and determining a corresponding prediction error for each of the selected subset of network configurations;
e) updating the instantaneous network configuration set as a function of the prediction errors and the at least one further optimization target of the network configuration set and the selected network configurations; and
f) selecting the suitable network configuration from the updated instantaneous network configuration set.

18. The method as recited in claim 17, wherein the probability distribution is antiproportional to a density estimate, the density estimate being calculated as a function of the instantaneous network configuration set, characterizing a density of the instantaneous network configuration set with respect to the at least one further optimization target.

19. The method as recited in claim 17, wherein steps a) through e) are carried out iteratively multiple times, and wherein the method is ended when an abort condition is met, the abort condition involving an occurrence of at least one of the following events:
a predetermined number of iterations has been reached,
a predetermined prediction error value has been reached by at least one of the network configuration variants.

20. The method as recited in claim 17, wherein those network configurations which have lowest probabilities as a function of the probability distribution of the network configurations of the instantaneous network configuration set are selected from the set of network configuration variants.

21. The method as recited in claim 20, wherein the network configurations are selected from the set of network configuration variants as a function of a kernel density estimate, that is ascertained from the instantaneous network configuration set.

22. The method as recited in claim 17, wherein the training data are predefined by input parameter vectors and output parameter vectors associated with the input parameter vectors, the prediction error of each of the selected subset of network configurations being determined as a measure that results from deviations between model values that result from the neural network, determined by the corresponding network configuration, based on the input parameter vectors, and from the output parameter vectors associated with the input parameter vectors.

23. The method as recited in claim 17, wherein the prediction errors for the selected subset of network configurations are ascertained by a training using the training data under training conditions that are predetermined together, the training conditions specifying a number of training passes and/or a training time and/or a training method.

24. The method as recited in claim 17, wherein the suitable network configuration is selected from the instantaneous network configuration set, based on an overall cost function that is a function of the prediction error and resource costs with regard to the at least one optimization target.

25. The method as recited in claim 17, wherein the updating of the instantaneous network configuration set is carried out in such a way that an updated instantaneous network configuration set contains only those network configurations from the instantaneous network configuration set and from the selected subset of network configurations which, with regard to the prediction error and at least one of the at least one further optimization target, are better than any of the other network configurations.

26. The method as recited in claim 17, wherein the updating of the instantaneous network configuration set is carried out by adding the selected subset of network configurations to the instantaneous network configuration set to obtain an expanded network configuration set, and subsequently removing from the expanded network configuration set those network configurations which, with regard to the prediction error and all of the at least one further optimization target, are poorer than at least one of the other network configurations to obtain the updated network configuration set.

27. A method for controlling a robot or a vehicle or a tool or a work machine, comprising the following steps:
ascertaining a suitable network configuration for the neural network for a predefined application for implementing functions of a technical system including the robot, or the vehicle, or the tool, or the work machine, the predefined application being determined in the form of training data, the network configuration indicating an architecture of the neural network, the ascertaining of the suitable network configuration including the following steps:
a) providing an instantaneous network configuration set that includes network configurations, the instantaneous network configuration set corresponding to a Pareto set with regard to a prediction error and at least one further optimization target;
b) providing a set of network configuration variants as a function of variations of the network configurations of the instantaneous network configuration set;
c) selecting a subset of network configurations from the provided set of network configuration variants as a function of a probability distribution, the probability distribution characterizing a distribution of the instantaneous network configuration set, with respect to the at least one further optimization target;
d) training neural networks of each of the selected subset of network configurations and determining a corresponding prediction error for each of the selected subset of network configurations;
e) updating the instantaneous network configuration set as a function of the prediction errors and the at least one further optimization target of the network configuration set and the selected network configurations; and
f) selecting the suitable network configuration from the updated instantaneous network configuration set; and
controlling the robot, or the vehicle, or the tool, or the work machine, using the neural network.

28. A device for ascertaining a suitable network configuration for a neural network for a predefined application for implementing functions of a technical system, the technical system including a robot, or a vehicle, or a tool, or a work machine, the application being determined in the form of training data; the network configuration indicating an architecture of the neural network, the device configured to:
a) provide an instantaneous network configuration set that includes network configurations, the instantaneous network configuration set corresponding to a Pareto set with regard to a prediction error and at least one further optimization target;
b) provide a set of network configuration variants;
c) select network configurations from the set of network configuration variants as a function of a probability distribution of the network configurations of the instantaneous network configuration set with regard to the at least one further optimization target;
d) train neural networks of each of the selected network configurations and determining a corresponding prediction error for each of the selected network configurations;
e) update the instantaneous network configuration set as a function of the prediction errors and the at least one further optimization target of the network configuration set and the selected network configurations; and
f) select the suitable network configuration from the updated instantaneous network configuration set.

29. A control unit configured to control functions of a technical system, the technical system including a robot, or a vehicle, or a tool, or a work machine, the control unit including a neural network that is configured by an ascertained suitable network configuration which indicates an architecture of the neural network, the suitable network configuration being ascertained by:
a) providing an instantaneous network configuration set that includes network configurations, the instantaneous network configuration set corresponding to a Pareto set with regard to a prediction error and at least one further optimization target;
b) providing a set of network configuration variants as a function of variations of the network configurations of the instantaneous network configuration set;
c) selecting a subset of network configurations from the provided set of network configuration variants as a function of a probability distribution, the probability distribution characterizing a distribution of the instantaneous network configuration set, with respect to the at least one further optimization target;
d) training neural networks of each of the selected subset of network configurations and determining a corresponding prediction error for each of the selected subset of network configurations;
e) updating the instantaneous network configuration set as a function of the prediction errors and the at least one further optimization target of the network configuration set and the selected network configurations; and
f) selecting the suitable network configuration from the updated instantaneous network configuration set.

30. A non-transitory electronic memory medium on which is stored a computer program for ascertaining a suitable network configuration for a neural network for a predefined application for implementing functions of a technical system including a robot, or a vehicle, or a tool, or a work machine, the predefined application being determined in the form of training data, the network configuration indicating an architecture of the neural network, the computer program, when executed by a computer, causing the computer to perform the following steps:
a) providing an instantaneous network configuration set that includes network configurations, the instantaneous network configuration set corresponding to a Pareto set with regard to a prediction error and at least one further optimization target;
b) providing a set of network configuration variants as a function of variations of the network configurations of the instantaneous network configuration set;
c) selecting a subset of network configurations from the provided set of network configuration variants as a function of a probability distribution, the probability distribution characterizing a distribution of the instantaneous network configuration set, with respect to the at least one further optimization target;
d) training neural networks of each of the selected subset of network configurations and determining a corresponding prediction error for each of the selected subset of network configurations;
e) updating the instantaneous network configuration set as a function of the prediction errors and the at least one further optimization target of the network configuration set and the selected network configurations; and
f) selecting the suitable network configuration from the updated instantaneous network configuration set.
